(19) United States
(12) Patent Application Publication
(10) Pub. No.: US 2005/0255342 A1
(43) Pub. Date: Nov. 17, 2005

(54) Fuel cell stack and fastening and reinforcing mechanisms for a fuel cell stack

(76) Inventors: Dong-Hun Lee, Suwon-si (KR); Kyu-Nam Han, Suwon-si (KR)

Correspondence Address: CHRISTIE, PARKER & HALE, LLP, PO BOX 7068, PASADENA, CA, 91109-7068, US

(21) Appl. No.: 11/124,597

(22) Filed: May 9, 2005

(30) Foreign Application Priority Data
May 11, 2004 (KR) 10-2004-0032961

(51) Int. Cl. H01M 8/00

(52) U.S. Cl. 429/12; 429/33; 429/34

(57) ABSTRACT

A stack for a fuel cell system which can include a simplified fastening structure and a fuel cell system having the stack are shown. The stack includes at least one electricity generator, a housing, and a cover. The electricity generator includes a MEA and separators located on both surfaces of the MEA. The housing has an internal space in which the electricity generator is positioned, and a cover coupled to the housing to fix the electricity generator in place. A number of various mechanisms are shown for holding the housing and the cover together and for fixing the stacks in place. A number of reinforcing elements and structural shapes are also shown that yield a stronger housing and cover assembly that resists buckling and other forms of stress.

### CROSS REFERENCE TO RELATED APPLICATION

This application claims priority to and the benefit of Korean Patent Application No. 10-2004-0032961, filed on May 11, 2004 in the Korean Intellectual Property Office, the entire content of which is incorporated herein by reference.

### BACKGROUND OF THE INVENTION

1. Field of the Invention

The present invention relates to a fuel cell and more particularly to improved fastening mechanisms for stacks in a fuel cell and to improved mechanisms for reinforcing the fuel cell stacks.

2. Description of the Related Art

In general, a fuel cell is an electricity generating system directly converting chemical reaction energy into electric energy through an electrochemical reaction between the oxygen in air and the hydrogen contained in hydrocarbon materials such as methanol, ethanol, and natural gas.

Such a fuel cell can generate electricity and provide heat as a byproduct of the electricity generation. The electricity and heat, both of which can be simultaneously used, are generated without combustion through an electrochemical reaction between a fuel gas and an oxidant.

A recently developed polymer electrolyte membrane fuel cell (PEMFC) includes a fuel cell body called a stack, a fuel tank, and a fuel pump for supplying fuel to the stack from the fuel tank. The PEMFC may further include a reformer for reforming the fuel to generate hydrogen and for supplying the generated hydrogen to the stack in the course of supplying the fuel stored in the fuel tank to the stack.

In the PEMFC, the fuel stored in the fuel tank is supplied to the reformer by the fuel pump. Subsequently, the reformer reforms the fuel and generates the hydrogen gas. The stack causes the hydrogen and the oxygen to electrochemically react with each other, thereby generating electric energy.

In the fuel cell system described above, the stack generating the electricity includes unit cells that are successively stacked together. Each unit cell has a membrane-electrode assembly (MEA) and separators that closely sandwich the unit cell on both of its surfaces. The separators positioned at two outermost sides of the stack may be used as end plates.

The MEA has an anode electrode and a cathode electrode attached to the two surfaces of an electrolyte membrane on both sides. The separators separate the membrane-electrode assemblies. The separators simultaneously function as a conduit through which the hydrogen and the oxygen required for reaction in a fuel cell are supplied to the anode electrode and the cathode electrode of the MEA. The separators also function as a conductor connecting in series the anode electrode and the cathode electrode of each MEA. In the art, the separators are also called bipolar plates.

In a stack having the above-mentioned structure, the stacked unit cells are typically fastened to one another to form a single body, in order to prevent fuel leakage and in order to function as a cell. For this purpose, the unit cells may be bonded with an adhesive to form a single body. Alternatively, the unit cells may be fastened by pressing them together using the end plates.

An example of the pressing-type fastening structure using the end plates is shown in FIG. 11. In FIG. 11, the conventional fastening structure of a fuel cell stack includes fastening rods 220 inserted into holes formed in two end plates 210 which support two ends of a stack 200. Nuts 230 are fastened to male screws formed at the ends of the fastening rods 220 to fix the end plates in place. By fastening the nuts 230 to the male screws formed at the two ends of the fastening rod 200 inserted into the holes formed in end plates 210, the two end plates 210 can be pressed, thereby fixing the stack with a proper pressure.

However, the conventional structure described above requires many components such as bolts, nuts, and a fastening rod washer, which increase the cost and the time needed for assembly and disassembly. In addition, this conventional structure increases the overall volume of the stack, making it difficult to use the stack in a small fuel cell.

### SUMMARY OF THE INVENTION

In accordance with the present invention a simplified fastening structure for a stack in a fuel cell is provided, as well as a fuel cell system including the stack. Reinforcing structures for a fuel cell stack are also presented.

According to one aspect of the present invention, a stack for a fuel cell system is provided. The stack includes at least one electricity generator, a housing and a cover. The electricity generator includes a MEA and separators located on both surfaces of the MEA. The housing has an internal space in which the electricity generator is positioned, and the cover is coupled to the housing to fix the electricity generator in place. Coupling means are included for coupling the housing to the cover while holding the electricity generator in place. The coupling means may be formed as integral parts of the housing and the cover and are capable of coupling the housing and the cover at least partially along a circumference of the housing and the cover.

A plurality of holes may be formed in at least one of the housing and the cover.

A buffer member may be formed on an inner surface of at least one of the housing and the cover to elastically support the electricity generator. Holes may be formed in the buffer member to correspond to holes formed in the housing and the cover.

The housing may have a bottom surface and side surfaces extending from the bottom surface and an internal space with an open end, for example, forming an open box. The MEA and the separators may be sequentially stacked to be substantially parallel or perpendicular to the bottom surface of the housing.

A protrusion may be formed on the outer surface of the housing and a locking latch, which elastically locks to the protrusion, may be formed at the cover. The housing and the cover may be coupled to each other by the protrusion and the locking latch. The protrusion may be intermittently formed with gaps in between protruding portions or continuously formed along the outer surface of the housing. The locking latch may have a triangular cross-section with a narrow front end.

When the housing and the cover each forms a container with one open end, the coupling means may include L-shaped bent portions that bend outwardly and are formed at the open ends of the housing and the cover. In this case, the housing and the cover may be coupled to each other by fixing means including a bolt and a nut. The bolt and the nut may be used to couple the L-shaped bent portions at front ends of the housing and the cover.

The housing and the cover may be coupled to each other by welding them together.

The housing and the cover may be made of metal or plastic.

Surfaces of the housing and the cover may be corrugated and formed with concave portions and convex portions longitudinally extending. Alternatively, reinforcing members may be formed on at least one surface of the housing and the cover.

According to another aspect of the present invention, a fuel cell system comprising the above-mentioned stack is provided that includes a fuel supply unit for supplying fuel to the stack, and an air supply unit for supplying air to the stack.

The fuel cell system may employ a PEMFC scheme or a direct oxidation fuel cell (DOFC) scheme.

### BRIEF DESCRIPTION OF THE DRAWINGS

FIG. 1 is a diagram schematically illustrating a fuel cell system according to an embodiment of the present invention.

FIG. 2 is a perspective view illustrating a stack of a fuel cell system according to a first embodiment of the present invention.

FIG. 3 is an exploded perspective view illustrating the stack of the fuel cell system of the first embodiment of the present invention.

FIG. 4A is a cross-sectional view taken along Line IV-IV of FIG. 2.

FIG. 4B is an enlarged view of a portion of FIG. 4A.

FIG. 5 is a perspective view illustrating a housing according to a modified example of the first embodiment.

FIG. 6A is a cross-sectional view illustrating a stack of a fuel cell system according to a second embodiment of the present invention.

FIG. 6B is an enlarged view of a portion of FIG. 6A.

FIG. 7A is a cross-sectional view illustrating a stack of a fuel cell system according to a third embodiment of the present invention.

FIG. 7B is an enlarged view of a portion of FIG. 7A.

FIG. 8A is a cross-sectional view illustrating a stack of a fuel cell system according to a fourth embodiment of the present invention.

FIG. 8B is an enlarged view of a portion of FIG. 8A.

FIG. 9 is a perspective view illustrating a stack of a fuel cell system according to a fifth embodiment of the present invention.

FIG. 10 is a perspective view illustrating a stack of a fuel cell system according to a sixth embodiment of the present invention.

FIG. 11 is a side view illustrating a fastening structure of a stack of a conventional fuel cell system.

### DETAILED DESCRIPTION

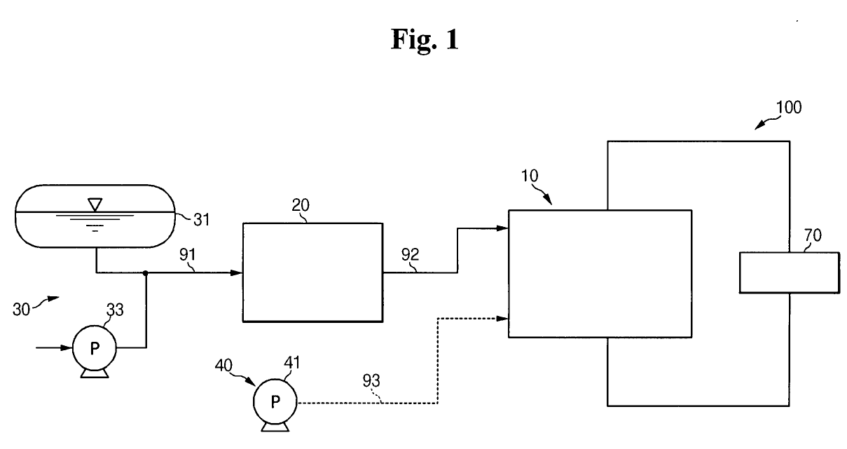

FIG. 1 is a schematic diagram illustrating a fuel cell system according to one embodiment of the present invention. In FIG. 1, a fuel cell system 100 includes a reformer 20 for reforming liquid fuel to generate hydrogen, a stack 10 for converting electrochemical reaction energy of a reaction between the hydrogen generated by the reformer 20 and the air outside into electric energy, a fuel supply unit 30 for supplying a liquid fuel to the reformer 20, an air supply unit 40 for supplying air to the stack 10, and a cooler 70 for cooling the air supply unit 40 and the stack 10. A fuel cell system employing a DOFC scheme does not include a reformer.

While the present invention is not limited to a fuel cell system employing a PEMC, this type of fuel cell structure is used to demonstrate embodiments of the present invention.

In the fuel cell system shown in FIG. 1, the reformer 20 uses a reformation reaction to convert the liquid fuel into the hydrogen gas required for generation of electricity in the stack 10. The reformer 20 also reduces the concentration of carbon monoxide contained in the hydrogen gas produced.

The reformer 20 typically includes a reformation unit which reforms the liquid fuel to generate the hydrogen gas and a carbon monoxide reducing unit which reduces the concentration of carbon monoxide in the hydrogen gas produced. The reformation unit converts the fuel into reformed gas abundant in hydrogen by a catalytic reaction such as a steam reformation, a preferential oxidation, or an auto-thermal reaction. The carbon monoxide reducing unit reduces the concentration of carbon monoxide in the reformed gas by using a catalytic reaction such as water-gas shift (WGS) and preferential oxidation, or refinement of hydrogen with a separation membrane. The reformer 20 can be connected to the stack 10 through a second supply line 92.

The fuel supply unit 30 includes a fuel tank 31 which stores liquid fuel and a fuel pump 33 which is connected to the fuel tank 31. The fuel pump 33 has a function of discharging the liquid fuel stored in the fuel tank 31 from the fuel tank 31 with a predetermined pumping power. The fuel supply unit 30 and the reformer 20 can be connected to each other through a first supply line 91.

The air supply unit 40 includes an air pump 41 which sucks and supplies external air to the stack 10. The air supply unit 40 and the stack 10 can be connected to each other through a third supply line 93.

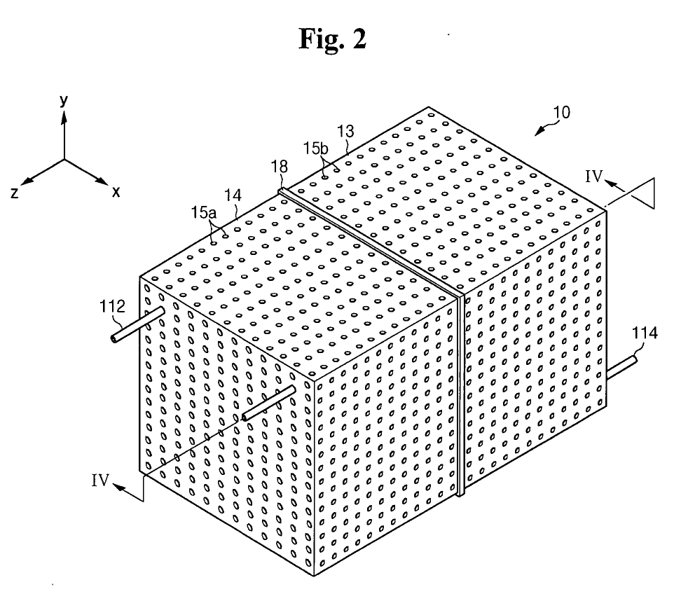

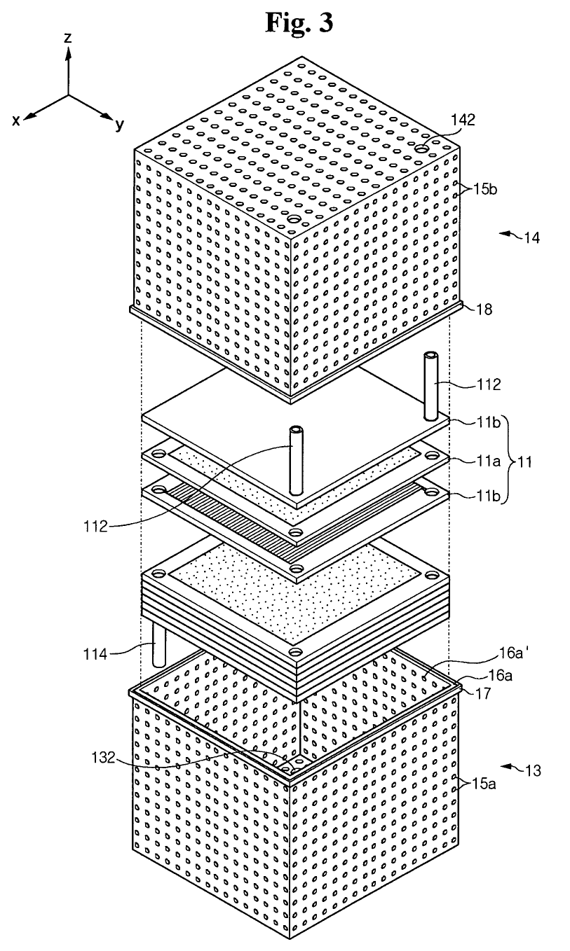

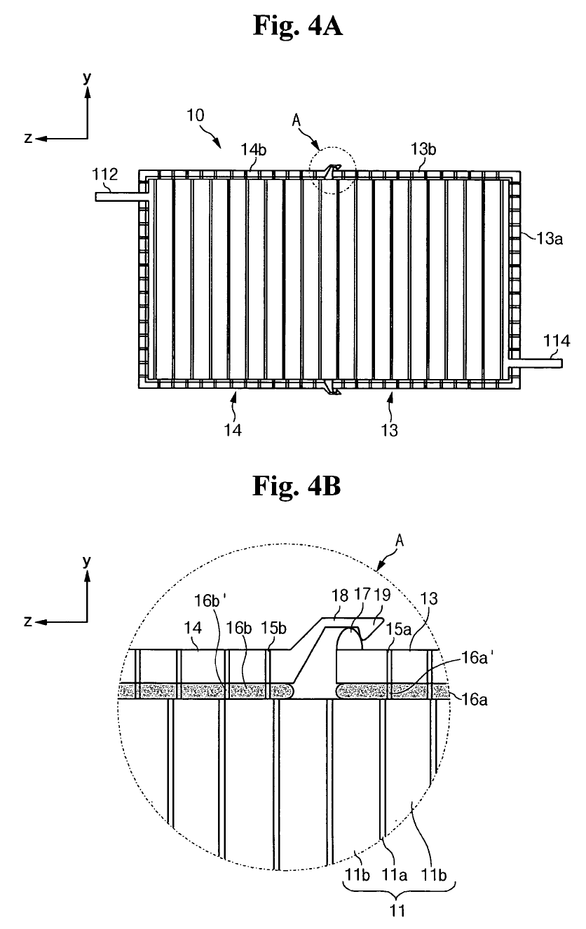

FIG. 2 is a perspective view illustrating a stack of a fuel cell system, according to a first embodiment of the present invention, and FIG. 3 is an exploded perspective view illustrating the stack of the fuel cell system of FIG. 2. FIG. 4A is a cross-sectional view taken along Line IV-IV of FIG. 2. FIG. 4B is an enlarged view of the portion “A” shown in FIG. 4A.

As shown in FIGS. 2, 3, and 4A, the stack 10 used in the fuel cell system 100 includes at least one electricity generator 11. Each electricity generator 11 causes an oxidation and reduction reaction between the hydrogen gas reformed by the reformer 20 and the oxygen obtained from external air in order to generate electric energy. Each electricity generator 11 constitutes a unit cell for generating electricity.

The electricity generator 11 includes a MEA 11a which oxidizes and reduces the hydrogen gas and the air, and separators 11b which supply the hydrogen gas and the air to the MEA. In the electricity generator 11, the separators 11b are located on both surfaces of the MEA 11a.

The separators 11b positioned at the sides of the outermost electricity generators 11 can be connected to inlets 112 and outlets 114. The hydrogen gas and air are supplied to hydrogen and air passages of the separators 11b, respectively, through the inlets 112. Hydrogen and air not reacting and remaining in the MEA 11a are discharged through the outlets 114.

In order to hold the electricity generators 11 together with a constant pressure, the stack 10 for a fuel cell system includes a housing 13 and a cover 14 coupled to each other. Holes 132 and 142 are formed in the housing 13 and the cover 14 so as to connect the inlets 112 and the outlets 114 to the outside.

The housing 13 has a bottom surface 13a and side surfaces 13b extending from the bottom surface 13a to contain an inner space with one open end. The housing 13 may be likened to a box with an open end. A plurality of holes 15a are formed in the bottom surface 13 and the side surfaces 13b of the housing 13 so as to allow a coolant for cooling the stack 10 to flow through.

A buffer member 16a for buffering external impacts or vibrations and elastically supporting the electricity generators 11 may be attached to the inner surface of the housing 13. Holes 16a′ are formed in the buffer member 16a to correspond to the holes 15a formed in the housing 13, so that the coolant can flow through the housing 13 and the buffer member 16a.

In the embodiment shown, the cover 14 has substantially the same structure as the housing 13. That is, the cover 14 contains an internal space of which one end is open, and a plurality of holes 15b are formed through the cover 14. A buffer member 16b is formed in the inner surface of the cover and has holes 16b′ corresponding to the holes 15b formed in the cover 14.

The housing 13 and the cover 14 may be made of metals, plastics, or a variety of other materials.

The electricity generators 11 are sequentially stacked in the internal spaces of the housing 13 and the cover 14 through the open ends of the housing 13 and the cover 14. For example, in the embodiment shown, the electricity generators 11 are stacked such that the surfaces of the membrane-electrode assemblies 11a and the separators 11b are parallel to the bottom surface 13a of the housing 13. In FIG. 4, the membrane-electrode assemblies 11a and the separators 11b are stacked along the Z-axis of the figure with their planes parallel to the bottom surface 13a of the housing 13 and perpendicular to the Z-axis.

In the embodiment shown in FIGS. 2, 3, 4A, and 4B, the electricity generators 11 are fixed in place under a pressure created by coupling the housing 13 and the cover 14. The housing 13 and the cover 14 are coupled using fixing means formed on the side surfaces 13b, 14b of the housing 13 and the cover 14 where the sides of housing 13 and the cover 14 end. These fixing means may be formed around the circumference of the housing 13 and the cover 14 near the open end of, for example, the box-like structure of the housing 13 and the cover 14 shown in FIG. 3. These fixing means may be formed as extensions of the open ends and as an integral part of the housing 13 and cover 14.

The fixing means, shown in more detail in FIG. 4B, includes a protrusion 17 formed in the housing 13 and an elastic member 18 formed in the cover 14. As shown in FIG. 4B, the protrusion 17 protrudes outward from the open end of the housing 13. The elastic member 18 extends down from the open end of the cover 14 and is positioned outside the protrusion 17 encompassing the protrusion 17 on two sides. A locking latch 19 which is capable of elastically locking to the protrusion 17 is formed at the end of the elastic member 18. The protrusion 17 may be formed integrally as a part of the housing 13. The elastic member 18 and the locking latch 19 may be formed integrally as parts of the cover 14.

The cover 14 is coupled to the housing 13, by applying a degree of pressure that causes the locking latch 19 to slide over the protrusion 17 when the cover 14 comes in contact with the housing 13. In the locking process, the elastic member 18 is first elastically bent or strained and then restored while going over the protrusion 17, so that the locking latch 19 is locked and coupled to the protrusion 17.

The locking latch 19, formed with the elastic member 18, may have a triangular section with a narrow front end, and the protrusion 17 may have a rounded end. The interaction of the narrow end of the triangular locking latch 19 and the rounded shape of the locking latch 19 causes the locking latch 19 to easily slide over the protrusion 17 at the time of coupling the housing 13 to the cover 14. At the same time, the locking latch 19 and the protrusion 17 cannot be easily separated after the locking latch 19 is locked to the protrusion 17.

Because the stack 10 can be simply assembled using the above mechanism, it is possible to reduce the number of parts required for assembling the stack, thereby reducing cost. It is also possible to simplify the stack assembling process, thereby enhancing throughput. In addition, because the stack can be easily assembled and disassembled, it is possible to reduce time and labor required for disassembling the stack at the time of repair. Because the housing 13 and the cover 14 are coupled by small-volume fixing means formed at the open ends of the housing 13 and the cover 14, it is also possible to minimize the overall volume of the stack 10.

The present invention is not limited to in the embodiment shown in FIGS. 2, 3, 4A, and 4B, where the electricity generators 11 are positioned in the internal space of the cover 14. In other embodiments, the cover may not have an internal space. Therefore, a cover may have any structure as long as it is capable of fixing the electricity generators 11 and holding them together under a constant pressure.

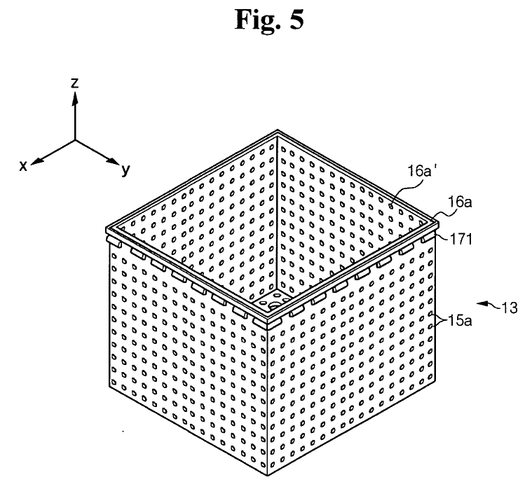

Also, the invention is not limited to the embodiment shown in FIG. 3, where the protrusion 17 is continuously formed to surround the open end of the housing 13. As shown in FIG. 5, in a modified example of the present invention, the protrusion 171 may be formed with intermittent gaps.

Second to sixth embodiments of the present invention are described below. Because these embodiments have a basic structure similar to the first embodiment, detailed descriptions of the same or similar elements are omitted while different elements are described in more detail. Same or similar elements are denoted by the same reference numerals in the figures.

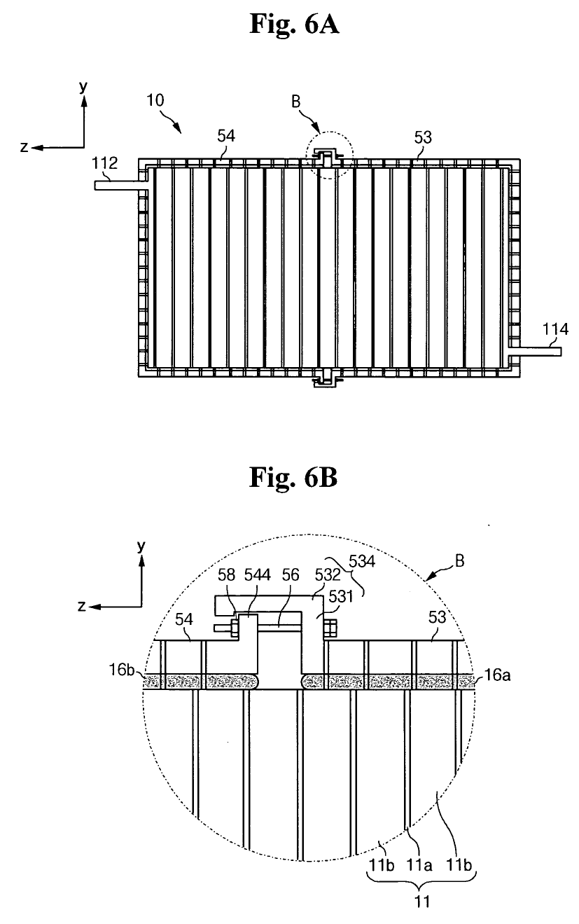

FIG. 6A is a cross-sectional view illustrating a stack of a fuel cell system according to a second embodiment of the present invention. FIG. 6B is an enlarged view of the portion “B” shown in FIG. 6A. In the second embodiment of the present invention, a housing 53 and a cover 54 are coupled with fixing means including bolts 56 and nuts 58, fixing the electricity generators 11 together with a constant pressure. L-shaped bent portions 534, 544 are formed at the open ends of the housing 53 and the cover 54, respectively and as extensions of the housing 53 and the cover 54. The housing 53 and the cover 54 can be more easily coupled by fastening the L-shaped bent portions 534, 544 together with the bolts 56 and the nuts 58. Because of above fastening structure, the stack 10 can have stronger fastening power. Therefore, it is possible to prevent separation of the stack 10 due to external impacts and other stresses.

The L-shaped bent portion 534, formed as an extension of the housing 53, may have a portion 531 in which the bolt 56 and the nut 57 are fastened, and a portion 532 which extends from the portion 531 up to the upper portion of the L-shaped bent portion 544 of the cover 54 to cover a gap between the housing 13 and the cover 14.

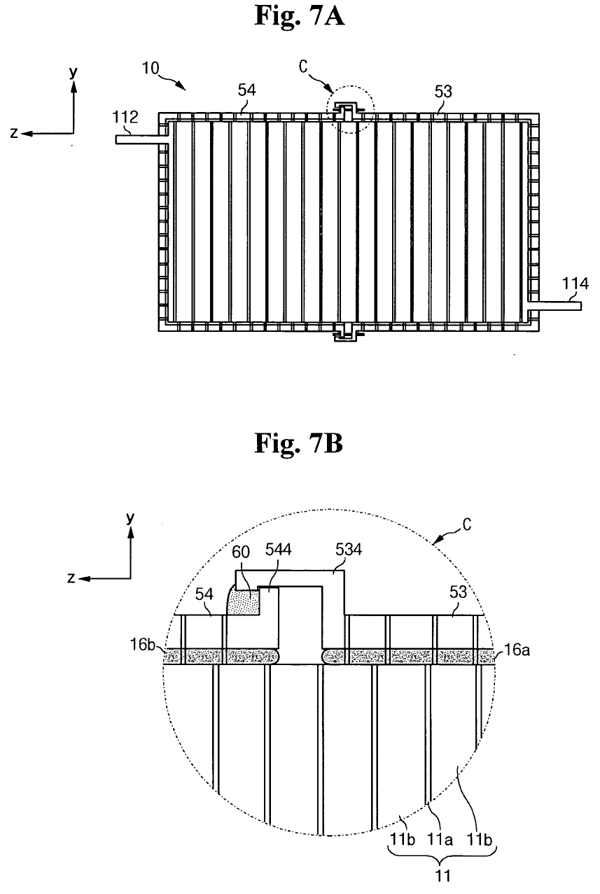

FIG. 7A is a cross-sectional view illustrating a stack of a fuel cell system according to a third embodiment of the present invention. FIG. 7B is an enlarged view of the portion “C” shown in FIG. 7A. In the third embodiment of the present invention shown in FIGS. 7A and 7B, the housing 53 and the cover 54 are coupled by a welded portion 60 formed by welding the end of the housing 53 and the end of the cover 54.

The housing 53 and the cover 54, shown in FIG. 7B, include the L-shaped bent portions 534 and 544 of the second embodiment. However, the present invention is not limited to the arrangement shown and the housing 53 and the cover 54 may be welded using a variety of arrangements and shapes.

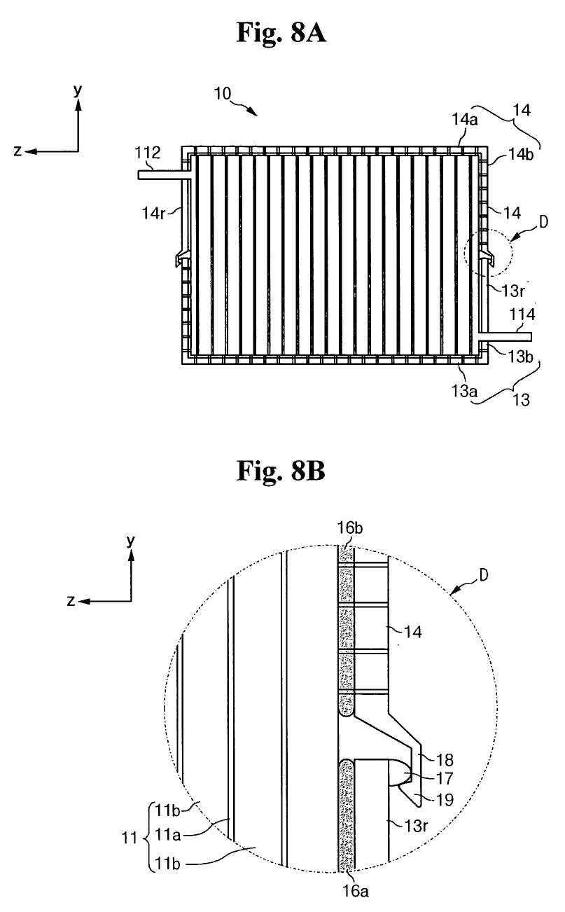

FIG. 8A is a cross-sectional view illustrating a stack of a fuel cell system according to a fourth embodiment of the present invention. FIG. 8B is an enlarged view of the portion “D” shown in FIG. 8A. In this embodiment, the orientation of the stacks of electricity generators 11 has changed with respect to the previous embodiments. In FIG. 8A, in the fourth embodiment of the present invention, the electricity generators 11 are stacked between both side surfaces 13b of the housing 13 such that the membrane-electrode assemblies 11a and the separators 11b are substantially perpendicular to the bottom surface 13a of the housing 13. In this embodiment, passages 13r and 14r for the inlet 112 and the outlet 114 are formed in the housing 13 and the cover 14, thereby making the stacking of the electricity generators 11 easier.

In the embodiment of FIGS. 8A and 8B, the electricity generators 11 are fixed and held together by pressure from the side surfaces of the housing 13. In this embodiment, the cover 14 fits over the housing 13, covering the open end of the housing 13. The side surfaces of the cover 14 also press together the membrane-electrode assemblies 11a and the separators 11b, holding and fixing the electricity generators 11 together.

FIG. 8B shows the housing 13 and the cover 14 coupled together using the latch of the first embodiment. However, the present invention is not limited to this mechanism of holding the housing 13 and cover 14 together.

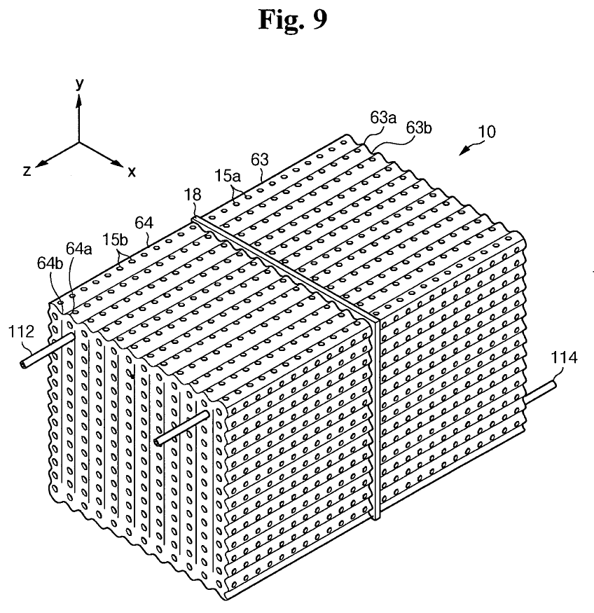

FIG. 9 is a perspective view illustrating a stack of a fuel cell system according to a fifth embodiment of the present invention. In this embodiment, the housing, the cover, or both may have corrugated surfaces for increased rigidity and strength. Concave portions 63a and 64a and convex portions 63b and 64b, which extend longitudinally, are alternately arranged on the surfaces of a housing 63 and a cover 64.

The rigidity of the housing 63 and the cover 64 can be increased by using this corrugated shape, thereby reinforcing the structure of the stack. In the embodiment shown in FIG. 9, at least one of the surfaces constituting the housing or the cover may have the above-mentioned corrugated shape.

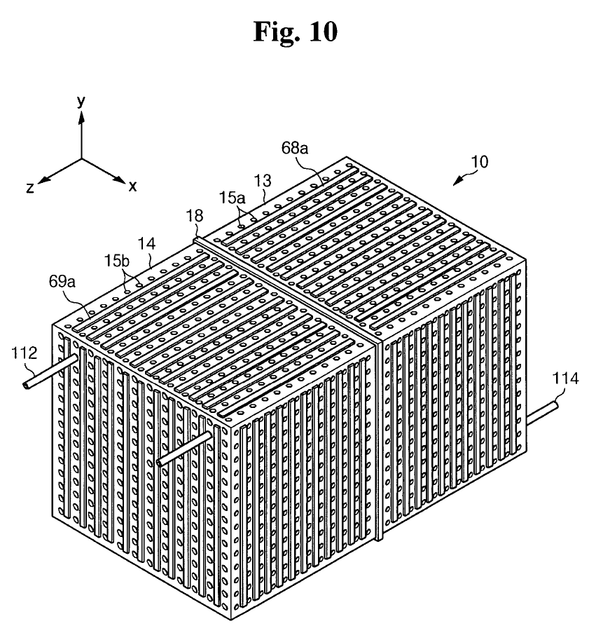

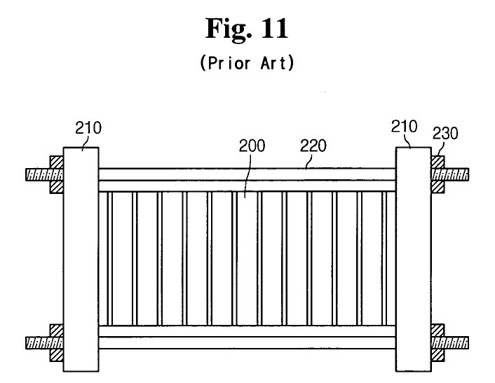

FIG. 10 is a perspective view illustrating a stack of a fuel cell system according to a sixth embodiment of the present invention. In FIG. 10, in the sixth embodiment of the present invention, reinforcing members 68a and 69a are formed on the surfaces of the housing 13 and the cover 14.

The reinforcing members 68a and 69a serve to prevent buckling failure due to application a large load or due to an increase in size of the housing 13 and the cover 14. In addition, the reinforcing members 68a and 69a can reinforce the structure of the stack.

Although some exemplary embodiments of the present invention have been described, the present invention is not limited to the embodiments and examples described, but may be modified in various forms without departing from the scope of the appended claims, the detailed description, and the accompanying drawings of the present invention. Therefore, it is natural that such modifications belong to the scope of the present invention.

1. A stack for a fuel cell system comprising:
at least one electricity generator including a membrane-electrode assembly and separators disposed on two opposing surfaces of the membrane-electrode assembly;
a housing having an internal space in which the at least one electricity generator is positioned; and
a cover coupled to the housing to fix the at least one electricity generator in place.

2. The stack for a fuel cell system of claim 1, further comprising:
coupling means for coupling the housing to the cover while holding the at least one electricity generator in place, the coupling means being formed as integral parts of the housing and the cover and capable of coupling the housing and the cover at least partially along a circumference of the housing and the cover.

3. The stack for a fuel cell system of claim 1, wherein a plurality of holes are formed through at least one of the housing and the cover.

4. The stack for a fuel cell system of claim 1, wherein a buffer member is formed on an inner surface of at least one of the housing and the cover to elastically support the at least one electricity generator.

5. The stack for a fuel cell system of claim 4,
wherein a plurality of holes are formed in at least one of the housing and the cover, and
wherein holes are formed through the buffer member to correspond to the holes formed in the housing and the cover.

6. The stack for a fuel cell system of claim 1, wherein the housing has a bottom surface and side surfaces extending from the bottom surface forming an internal space with an open end.

7. The stack for a fuel cell system of claim 6, wherein the membrane-electrode assembly and the separators are sequentially stacked to be substantially parallel to the bottom surface of the housing.

8. The stack for a fuel cell system of claim 6, wherein the membrane-electrode assembly and the separators are sequentially stacked to be substantially perpendicular to the bottom surface of the housing.

9. The stack for a fuel cell system of claim 2,
wherein the coupling means includes a protrusion formed continuously along an outer circumference of the housing and a locking latch formed along an outer circumference of the cover, and
wherein the protrusion and the locking latch are capable of coupling together the housing and the cover.

10. The stack for a fuel cell system of claim 9, wherein the protrusion is formed intermittently around a circumference of an open end of housing, resulting in more than one protruding portions, with gaps in between adjacent protruding portions.

11. The stack for a fuel cell system of claim 9, wherein the locking latch has a triangular cross-section with a narrow front end.

12. The stack for a fuel cell system of claim 2, wherein the coupling means are fixed together by fixing means including a bolt and a nut.

13. The stack for a fuel cell system of claim 2,
wherein the housing and the cover each forms a container with one open end,
wherein coupling means include L-shaped bent portions, bending outwardly, formed at the open ends of the housing and the cover, and
wherein the L-shaped bent portions are fastened together by a bolt and a nut.

14. The stack for a fuel cell system of claim 1, wherein the housing and the cover are coupled together by welding.

15. The stack for a fuel cell system of claim 1, wherein the housing and the cover are comprised of metal or plastic.

16. The stack for a fuel cell system of claim 1, wherein surfaces of the housing and the cover are corrugated with concave portions and convex portions longitudinally extending.

17. The stack for a fuel cell system of claim 1, wherein reinforcing members are formed on at least one surface of the housing and the cover.

18. A fuel cell system comprising:
a stack having at least one electricity generator including a membrane-electrode assembly and separators located on two opposite surfaces of the membrane-electrode assembly;
a housing having an internal space in which the at least one electricity generator is positioned, and a cover coupled to the housing to fix the at least one electricity generator in place;
a fuel supply unit for supplying fuel to the stack; and
an air supply unit for supplying air to the stack.

19. The fuel cell system of claim 18, wherein a reformer for reforming the fuel to generate hydrogen gas is further provided between the stack and the fuel supply unit.

20. The fuel cell system of claim 19, wherein the fuel cell system is a polymer electrolyte membrane fuel cell system or a direct oxidation fuel cell system.
